(19) United States
(12) Patent Application Publication
(10) Pub. No.: US 2026/0149884 A1
(43) Pub. Date: May 28, 2026

(54) INFORMATION PROCESSING APPARATUS, CONTROL METHOD, AND STORAGE MEDIUM

(71) Applicant: CANON KABUSHIKI KAISHA, Tokyo (JP)

(72) Inventor: Shohei YAMAUCHI, Kanagawa (JP)

(21) Appl. No.: 19/379,881

(22) Filed: Nov. 5, 2025

(30) Foreign Application Priority Data
Nov. 22, 2024 (JP) 2024-204138

(51) Int. Cl. H04N 23/695; H04N 23/69

(52) U.S. Cl. CPC H04N 23/695; H04N 23/69

(57) ABSTRACT

An information processing apparatus obtains information indicating a plurality of setting values for setting an angle of view of an image capturing apparatus, the plurality of setting values corresponding to a plurality of positions included in a predetermined path for performing image capture while moving the angle of view along the predetermined path, sets a target value for setting the angle of view different from the plurality of setting values, based on two setting values included in the plurality of setting values, and changes a setting of the image capturing apparatus toward the target value.

### BACKGROUND

### Field of the Technology

The present disclosure relates to technology for controlling an image capturing apparatus.

### Description of the Related Art

In recent years, with the increase of the video streaming market, there is a need for remotely controlling the pan, tilt, and zoom of an image capturing apparatus using a network and for capturing images while tracking an object. A known tracking and image capturing method includes an automated loop function in which a preset function storing a parameter for when capturing an image of a target viewpoint is used, parameters for a designated plurality of positions are pre-designated, and images are captured while cycling through these positions. Another example includes a trace function for controlling the image capturing apparatus to trace the user control in which a plurality of sets of parameters corresponding to the field of view or image quality of the image capturing apparatus are pre-recorded by user control and images are captured while referencing a set of parameters. For example, in a case where images are captured while tracking an object moving in a predetermined path such as at a tracking racing event, via the function described above, the image capturing apparatus can be controlled according to the pre-recorded parameters. Japanese Patent Laid-Open No. 2023-155733 describes a method for editing the recorded parameters for tracing.

For example, in a case where the movement speed of an object is different from the expected speed during image capture of a track racing event, such as when two athletes try to best one another, the image capture based on the pre-recorded parameters may stop functioning appropriately and user-friendliness may be impaired.

### SUMMARY

According to the present disclosure, technology for enhancing the user-friendliness of image capture based on a preset is provided.

According to one aspect of the present disclosure, there is provided an information processing apparatus obtaining information indicating a plurality of setting values for setting an angle of view of an image capturing apparatus, the plurality of setting values corresponding to a plurality of positions included in a predetermined path for performing image capture while moving the angle of view along the predetermined path, setting a target value for setting the angle of view different from the plurality of setting values, based on two setting values included in the plurality of setting values, and changing a setting of the image capturing apparatus toward the target value.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1A is a diagram illustrating a system configuration example.

FIG. 1B is a diagram illustrating an example of preset information.

FIG. 2 is a diagram illustrating an example of the hardware configuration of an information processing apparatus.

FIG. 3 is a diagram illustrating an example of the functional configuration of the information processing apparatus.

FIG. 4 is a diagram for describing an example of preset information and a target setting of an image capturing apparatus.

FIG. 5 is a diagram for describing an example of updating a target.

FIG. 6 is a diagram illustrating an example of the configuration of a controller.

FIG. 7 is a diagram illustrating an example of the flow of processing executed by the information processing apparatus.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### System Configuration

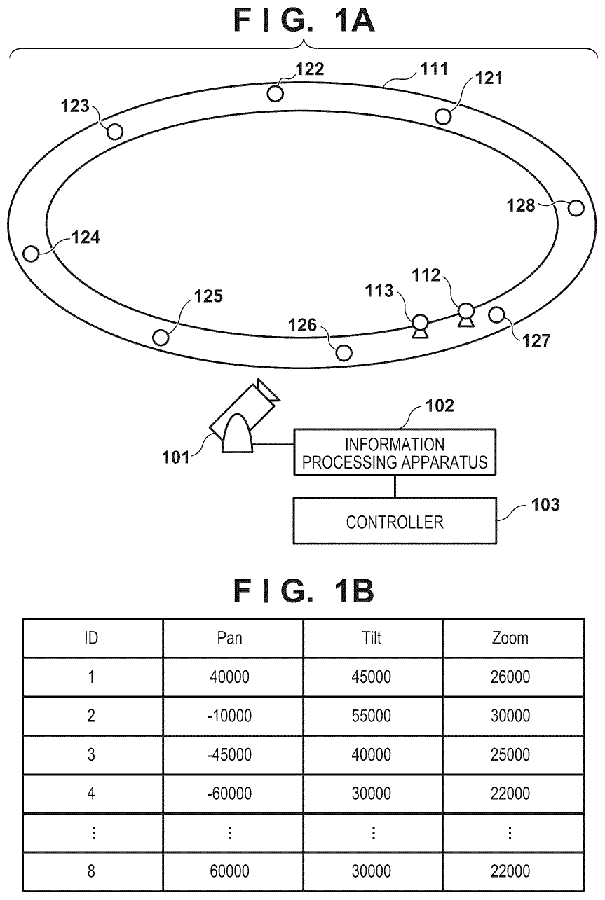

FIG. 1A is a diagram illustrating an example configuration of an image capturing system according to the present embodiment. The present image capturing system includes an image capturing apparatus 101, an information processing apparatus 102, and a controller 103. The image capturing apparatus 101 includes a function for capturing images while tracking objects 112 and 113, such as athletes, in a predetermined range such as a track 111 for track and field, for example, by changing at least one (PTZ value) of the pan value, the tilt value, and the zoom value over time. Note that in FIG. 1A, only one image capturing apparatus 101 is illustrated, but a plurality of the image capturing apparatuses 101 may be prepared. The information processing apparatus 102 obtains information indicating the current state and the like from the image capturing apparatus 101 or obtains information indicating a user operation from the controller 103 and executes information processing for controlling the area to be captured by the image capturing apparatus 101, for example. The controller 103 is a device used by the user to control the image capturing apparatus 101. Note that in a case where a plurality of the image capturing apparatuses 101 are provided, a plurality of the information processing apparatuses 102 and the controllers 103 may be prepared to correspond with the plurality of image capturing apparatuses 101. However this is merely an example, and one set of the information processing apparatus 102 and the controller 103 that collectively handle the plurality of image capturing apparatuses 101 may be prepared.

In the present embodiment, the information processing apparatus 102 controls the image capturing apparatus 101 to perform image capture of the objects 112 and 113 while moving the angle of view, which is the image capture target, along the track on the basis of preset information set in advance. The preset information is information including specific positions and PTZ values associated together as illustrated by positions 121 to 128 in the track, for example. In other words, the preset information is information for setting what composition the image capturing apparatus 101 will capture with respect to specific positions in the image capture target. FIG. 1B illustrates an example of the preset information. The preset information is allocated with identification information (an ID) for each position corresponding to the preset information, and a combination of setting information including a pan value (pan), a tilt value (tilt), and a zoom value (zoom) is associated with each ID. For example, the position 121 corresponds to ID=1, the position 122 corresponds to ID=2, the position 123 corresponds to ID=3, . . . , and the position 128 corresponds to ID=8. Note that pan and tilt indicated the rotation angle of the pan and tilt of the image capturing apparatus 101, or in other words, the orientation of the image capturing apparatus 101. Also, zoom indicates the horizontal angle of view of the image capturing apparatus 101. The unit of the pan value, the tilt value, and the zoom value in FIG. 1B is “a factor of one thousandth”, and a value of 10000 represents “10°”. For example, when ID=1 is designated as the start ID and ID=8 is designated as the end ID, the image capturing apparatus 101 obtains the PTZ value corresponding to each of ID=1 to ID=8. Note that by designating only the start ID and the end ID, the setting value of the IDs between the start ID and the end ID may be indicated to be used in order by increasing the ID by one each time. However, no such limitation is intended. For example, information indicating the order of the setting information to be used, such as start ID, second ID, third ID, and so on, may be obtained by the image capturing apparatus 101, and the image capturing apparatus 101 may obtain the PTZ values corresponding to the IDs included in the order.

Then, the image capturing apparatus 101 perform image capture while switching the PTZ values so that the PTZ value of the next ID (for example, ID=2) at used at the point in time when a predetermined amount of time has passed from the start of image capture using one of the PTZ values (for example, ID=1). The predetermined amount of time may be included in the setting information or may be separately input by a user operation or the like, for example. Also, in the time after the start of image capture using the PTZ value corresponding to the first ID until the timing corresponding to the subsequent second ID, the image capturing apparatus 101 may use an intermediate PTZ value to produce a gradual change from the PTZ value corresponding to the first ID to the PTZ value corresponding to the second ID. In other words, an interpolation value of the PTZ value between the two pieces of preset information may be calculated. For example, in a case where half of the time from the start time of the use of the PTZ value of the first ID to the transition to the second ID has passed, a value approximately in the middle between the PTZ value of the first ID and the PTZ value of the second ID may be used as the PTZ value. The image capturing apparatus 101 can perform image capture by causing the angle of view to move at each timing on the basis of the preset PTZ setting values as illustrated in FIG. 1B and tracking the objects 112 and 113.

In the present embodiment, also, the information processing apparatus 102 changes the angle of view captured by the image capturing apparatus 101 on the basis of a user operation via the controller 103. In this manner, the angle of view captured by the image capturing apparatus 101 is moved in line with a change in the movement speed of the objects 112 and 113, allowing the objects 112 and 113 to be appropriately tracked for image capture. In other words, even in a case where a user operation is received via the controller 103 and the speed that the objects 112 and 113 run around the track changes, the information processing apparatus 102 controls the image capturing apparatus 101 to track the objects 112 and 113 for image capture.

In the track event, when two athletes (the objects 112 and 113) try to best one another, the speed at which the objects run around the track changes. Thus, to appropriately perform image capture of the objects 112 and 113, the movement speed of the angle of view of the image capturing apparatus 101 needs to change to match the movement speed of the objects 112 and 113. However, with the cyclic image capturing function using preset information described above, the movement speed of the angle of view cannot be dynamically changed to match the movement of the objects. Also, if the angle of view moves near a position corresponding to designated preset information, the movement speed would decrease, and if the angle of view moves up to that position, it would temporarily stop. Thus, image capture while smoothly tracking the objects could not be performed.

In light of this situation, the present embodiment provides technology that enables image capture while smoothly tracking the objects 112 and 113 using automated image capture using preset information. In the present embodiment, the movement of the angle of view when a difference between a value (PTZ value) indicating the state of the image capturing apparatus 101 and a setting value (PTZ value) designated by preset information is equal to or less than a predetermined value is made to not slow down using a value (control value) for control separate from the setting values. For example, looking at two positions adjacent on the image capture path from among the plurality of angle of view positions defining the image capture path, a target position is set behind the second position corresponding to the second setting value used afterward as seen from the first position corresponding to the first setting value used first. Then, the setting value corresponding to the target position is set as the control value described above. Note that the first setting value and the second setting value may be expressed as coordinates, and the control value may be prepared so that, in this coordinate space on a straight line joining the first setting value and the second setting value, the second setting value may exist between the control value and the first setting value. In some cases, the straight line described above may be a predetermined curved line obtained by predetermined interpolation processing such as spline interpolation processing or the like. The speed of the change of the PTZ value decreasing before the second setting value can be prevented by setting the target for when changing the PTZ value of the image capturing apparatus 101 to the control value for the second setting value.

Also, in response to the difference between the current PTZ value of the image capturing apparatus 101 and the second setting value becoming equal to or less than a predetermined value (in other words, before approaching the control value), the setting value is updated to the third setting value subsequent to the second setting value. Note that update of the setting value may be performed in response to the difference between position corresponding to the second setting value and the position of the current angle of view becoming equal to or less than a predetermined value. This prevents the current PTZ value of the image capturing apparatus 101 from passing the setting value and approaching the control value. Also, according to this technology, the objects 112 and 113 can be tracked flexibly via user operation to match the movement speed of the objects 112 and 113. In other words, since update of the setting value to the next preset third setting value is performed on the basis of the difference between the current PTZ value of image capturing apparatus 101 and the second setting value, even if the change speed of the PTZ value changes, image capture along a preset path can be continued.

The configuration of the information processing apparatus 102 for executing such processing and the flow of the executed processing will be described below. Note that in the example of the present embodiment illustrated herein, the information processing apparatus 102 exists separate from the image capturing apparatus 101. However, the information processing apparatus 102 may be provided inside the image capturing apparatus 101, for example. In this case, the controller 103 existing remotely, for example, may transmit operation information to the information processing apparatus 102 inside the image capturing apparatus 101 via a network, and the information processing apparatus 102 may execute each item of processing described below on the basis of the operation information.

### Configuration of Information Processing Apparatus 102

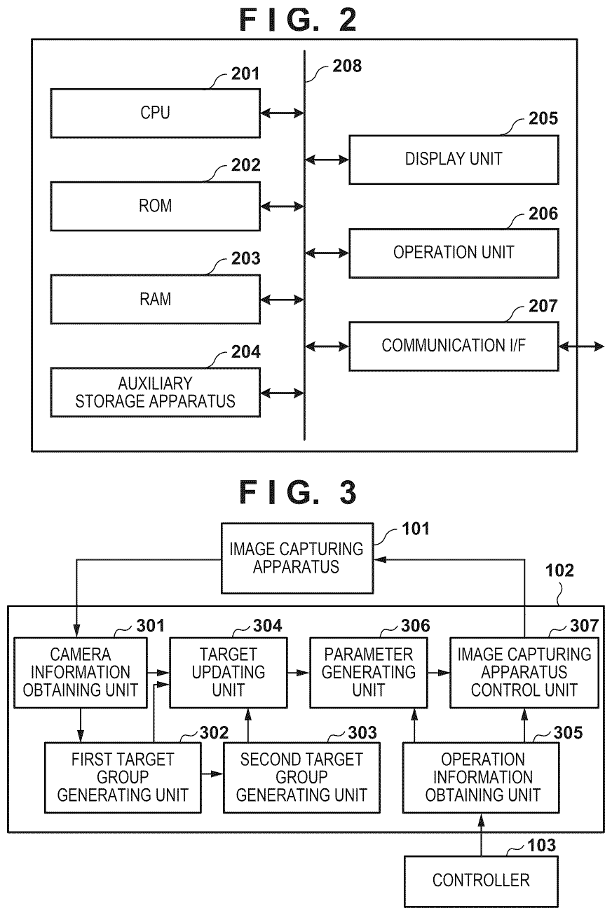

FIG. 2 illustrates an example of the hardware configuration of the information processing apparatus 102. The information processing apparatus 102, for example, includes a CPU 201, a ROM 202, a RAM 203, an auxiliary storage apparatus 204, a display unit 205, an operation unit 206, a communication I/F 207, and a bus 208. Note that CPU is an abbreviation for central processing unit, ROM is an abbreviation for read only memory, RAM is an abbreviation for random access memory, and I/F is an abbreviation for interface.

The CPU 201 implements each function of the information processing apparatus 102 by controlling the entire apparatus using computer programs and data stored in the ROM 202 and RAM 203. Note that the CPU 201 is an example of one or more processors and may be substituted by another processor such as a micro processing unit (MPU) or the like. Also, a dedicated hardware such as an application specific integrated circuit (ASIC), a digital signal processor (DSP), a field-programmable gate array (FPGA), or the like may be used instead of the CPU 201 or in addition to the CPU 201. Such a dedicated hardware may execute the processing described below in cooperation with the CPU 201 or by itself. The ROM 202 stores programs not requiring changes and the like, and the RAM 203 temporarily stores programs and data supplied from the auxiliary storage apparatus 204 and data and the like supplied from an external source via the communication I/F 207. In the present embodiment, the RAM 203 stores information of the tracking state representing the control state of the image capturing apparatus 101. Note that the ROM 202 and the RAM 203 are examples of one or more memory devices for the information processing apparatus 102 to permanently or temporarily store information, and an internal storage apparatus with similar functions may be used. The auxiliary storage apparatus 204 is a storage apparatus such as a hard disk drive (HDD) or a solid state drive (SSD), for example, that stores various types of data such as image data and audio data. The display unit 205 is constituted of a liquid crystal display device, a light-emitting diode (LED) device, or the like that visually presents information to the user. The display unit 205 displays a graphical user interface (GUI) or the like for the user to operate the information processing apparatus 102, for example. Note that the display unit 205 may have a function of presenting information via audio, vibration, or the like, for example. The operation unit 206 is an interface for receiving operations from the user. The operation unit 206 includes an interface connected to the controller 103, for example, and may be configured to obtain information indicating the user operation on the controller 103 from the controller 103 and transfer this information to the CPU 201. Also, the communication I/F 207 performs communication with and external network such as an Internet, for example. Also, the communication I/F 207 may be used for connecting to the controller 103 via a network, for example. The bus 208 connects the CPU 201 to the communication I/F 207 to one another. Note that “bus” is an example, and connection to one another may be established via a different configuration.

FIG. 3 illustrates an example of the functional configuration of the information processing apparatus 102. The information processing apparatus 102 includes a camera information obtaining unit 301, a first target group generating unit 302, a second target group generating unit 303, a target updating unit 304, an operation information obtaining unit 305, a parameter generating unit 306, and an image capturing apparatus control unit 307. These functional units may be implemented, for example, by the CPU 201 executing a program stored in the ROM 202 or the auxiliary storage apparatus 204. Also, at least one of these functional units may be implemented by dedicated hardware.

The camera information obtaining unit 301 obtains camera information transmitted from the image capturing apparatus 101. The camera information may include, for example, at least one of identification information for identifying the image capturing apparatus 101, date and time information, the current PTZ value, and preset information which is a target viewpoint recorded in advance. The camera information obtaining unit 301, for example, obtains the preset information in initialization processing and obtains the current PTZ value in regular processing after the subsequent start of image capture. The preset information is recorded in advance in accordance with the course of the track, for example, as described above using FIG. 1B. The camera information obtaining unit 301 receives a user operation via a user interface (UI) screen (not illustrated) in the initialization processing and obtains any preset information.

The first target group generating unit 302 generates a first target group including one or more first targets relating to PTZ values on the basis of preset information obtained in the initialization processing by the camera information obtaining unit 301. The first target is represented by a PTZ value corresponding to a specific point and is treated as information indicating the point passed by the angle of view when performing image capture to track an object with the image capturing apparatus 101. Thus, the first target corresponds to a setting value for controlling the angle of view of the image capturing apparatus 101. Note that the first target may be a PTZ value indicated by a preset. The first target group is generated so that a position captured using a PTZ value corresponding to the start ID from among the obtained preset information is set as the start point and a position to be captured using a PTZ value corresponding to the end ID from among the preset information is set as the goal point. Then, by controlling the image capturing apparatus 101 to apply the first target in order from the start point to the goal point, the angle of view can be moved along the preset path. Note that, for example, it may be set so that image capture is performed so that the angle of view moves to a position corresponding to the start ID after passing a position corresponding to the end ID. For example, in the example of FIGS. 1A and 1, the position 121 where image capture is performed using the PTZ value of ID=1 is the start point, and the position 128 where image capture is performed using the PTZ value of ID=8 is the goal point. The preset information indicates movement of the angle of view moving from the position 121, through the positions 122, 123, . . . , 127 where image capture is performed using the PTZ value corresponding ID=2, 3, . . . , 7 respectively, and reaching the position 128. Note that the first target group generating unit 302 may execute interpolation processing for between the two PTZ values included in the preset information and may generate one or more interpolation values as the first target. For the interpolation processing here, spline interpolation processing may be used, for example. By generating the first target group via interpolation processing, in a case where only a small number of pieces of preset information are prepared in advance, interpolation can be performed so that between the positions corresponding to the preset information is smoothly connected. In this manner, the number of pieces of preset information recorded in advance can be reduced.

The second target group generating unit 303 generates a second target group configured from a second target corresponding to the first target. The second target is treated as a target for when performing control so that the position captured by the image capturing apparatus 101 passes the position corresponding to the first target. For example, the second target group generating unit 303 sets the i-th second target on an extension line from a position corresponding to the i−1-th first target toward a position corresponding to the i-th first target so as to pass a position corresponding to the i-th first target. The second target corresponds to a setting value for controlling the angle of view of the image capturing apparatus 101.

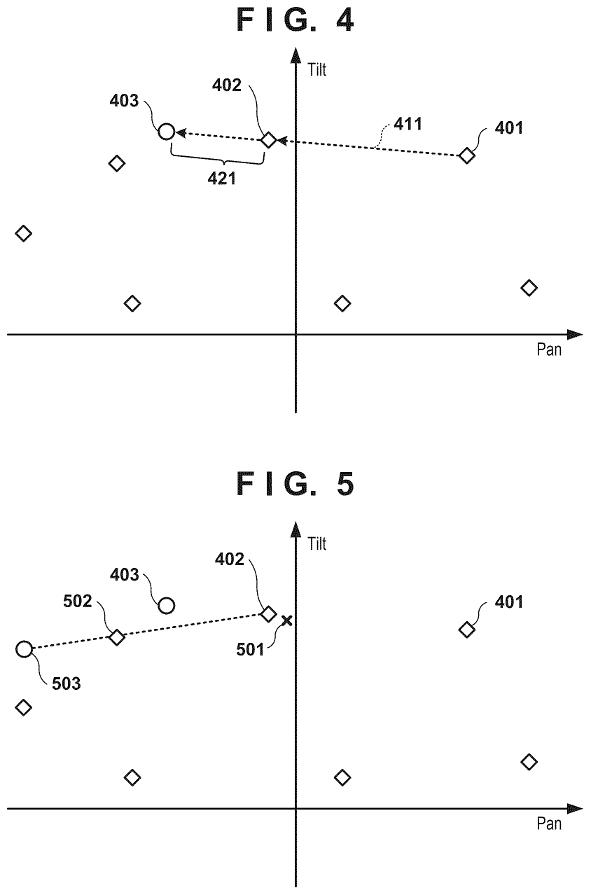

A method for generating the second target will now be described using FIG. 4. FIG. 4 illustrates a simple coordinate system with the horizontal axis representing the pan value and the vertical axis representing the tilt value. Note that the position to be captured by the image capturing apparatus 101 corresponds to the PT value (pan and tilt value). Thus, the coordinates representing the PT value has a 1-to-1 correspondence with the coordinates of the position to be captured. Thus, by changing the angle of view of the image capturing apparatus 101 toward each target value, the image capturing apparatus 101 can perform image capture of the set positions along the set path. In FIG. 4, a vector 411 from coordinates 401 corresponding to the i−1-th first target toward coordinates 402 corresponding to the i-th first target is illustrated. At this time, the second target (coordinates 403) is set at a position advanced from the coordinates 402 indicating the first target in the direction of the vector 411 by a discretionary distance value 421. The distance value 421 may be set in advance by receiving a user operation via the controller 103, UI screen (not illustrated), or the like, for example. Note that this is merely an example, and a certain value defined in advance in the system may be used as the distance value 421. The second target is calculated from the first target as represented by the following Formula (1).

$$\begin{matrix}{Target}_{i} = {CheckPoint}_{i} + \vec{NormalιzedVector} ( {CheckPoint}_{i - 1} , {CheckPoint}_{i} ) \\ * dist\end{matrix} \qquad ( 1 )$$

Here, CheckPointᵢ and Targetᵢ indicate the i-th first target and second target respectively. Also, \vec{NormalizedVector}(CheckPointᵢ₋₁, CheckPointᵢ), is the normalized vector 411 of a scalar of a predetermined value from the coordinates 401 indicating the i−1-th first target toward the coordinates 402 indicating the i-th first target. Also, dist represents the distance value 421 from the coordinates 402 indicating the i-th first target in the direction of the vector 411. The information processing apparatus 102 controls the PTZ value of the image capturing apparatus 101 toward the second target (coordinates 403) instead of the first target (coordinates 402) which is a passing point. Accordingly, the objects can be tracked for image capture without the movement speed of the PTZ value of the image capturing apparatus 101 decreasing at or near the position corresponding to the i-th first target. Note that the coordinates indicating the target may be the target value of the pan value and the tilt value, or in other words, the target value of the PT value.

The target updating unit 304 obtains camera information from the camera information obtaining unit 301 and obtains the first target group and the second target group from the first target group generating unit 302 and the second target group generating unit 303 respectively. Then, the target updating unit 304 determines whether or not the position of the angle of view corresponding to the current PTZ value of the image capturing apparatus 101 obtained as the camera information has passed the position corresponding to the currently set (for example, the i−1-th) first target. Note that this determination may be performed by comparing a distance between first coordinates with the current pan value and the tilt value of the image capturing apparatus 101 as an element and second coordinates with the pan value and the tilt value of the currently set first target as an element and a predetermined value set in advance. Also, the determination may be performed by comparing the distance between the center position of the angle of view being captured and the position corresponding to the first target and a predetermined value. In a case where the distance described above is equal to or less than the predetermined value, the target updating unit 304 may determine that the position of the angle of view corresponding to the current PTZ value of the image capturing apparatus 101 has passed the position corresponding to the currently set first target. Also, in a case where the target updating unit 304 determines that the position of the angle of view corresponding to the current PTZ value of the image capturing apparatus 101 has passed the position corresponding to the currently set first target, the target updating unit 304 executes update processing to newly use the next (for example, i-th) first target. Also, the target updating unit 304 updates the second target on the basis of the first target after the update. Note that the first target corresponding to the start point may be set as the initial value of the first target, and the second target calculated on the basis of the first target and a tentative target value corresponding to a predetermined position may be set as the initial value of the second target. Note that the tentative target value may be the initial value of the PTZ value of the image capturing apparatus 101, for example. In other words, the initial value of the second target may be calculated using a vector from the initial value of the PTZ value of the image capturing apparatus 101 toward the first target and a predetermined distance value as represented by Formula (1) described above. Also, the tentative target value may be a predetermined value set in advance such as an origin point of coordinates or the like. Also, the first value of the first target group may be used as the image capture start position of the image capturing apparatus 101, and the initial value of the first target may be used as the second value of the first target group. In this case, the initial value of the second target may be calculated on the basis of the first value and the second value of the first target group as represented in Formula (1).

Update of the target will now be described using FIG. 5. FIG. 5 corresponds to use values (coordinates 501) of the pan value and the tilt value obtained at a certain time t plotted onto the simple coordinate system of FIG. 4. At the certain time t, control is performed so that the PTZ value of the image capturing apparatus 101, after passing the coordinates 401 indicating the previous first target, passing the coordinates 402 indicating the first target with the coordinates 403 indicating the second target as the target. The target updating unit 304 updates the first target and the second target in response to the distance between the coordinates 501 indicating the use value of the pan value and the tilt value and the coordinates 402 indicating the first target becoming equal to or less than a predetermined value set in advance. For example, the target updating unit 304 updates the first target to the value indicated by coordinates 502 and updates the second target to the value indicated by coordinates 503. In this manner, in the present embodiment, the first target and the second target are updated in response to the PTZ value of the image capturing apparatus 101 approaching the set first target regardless of the time passed. Accordingly, image capture can be performed by appropriately moving through the positions specified in the preset information regardless of the movement speed of the PTZ value. Thus, image capture can be performed while appropriately tracking the objects 112 and 113 using an operation of movement speed of the PTZ value by the user without deviating from the image capture path specified by the preset information.

The operation information obtaining unit 305 obtains the operation information input from the controller 103 and notifies the parameter generating unit 306 and the image capturing apparatus control unit 307 of this operation information. The parameter generating unit 306 first obtains a value indicating the second target determined by the target updating unit 304. Next, the parameter generating unit 306 obtains the speed value from the operation information input from the operation information obtaining unit 305 and calculates each control speed of the PTZ values. Lastly, the parameter generating unit 306 determines the control parameter for controlling moving the PTZ value of the image capturing apparatus 101 toward the second target at the calculated control speed. The image capturing apparatus control unit 307 obtains the control parameter generated by the parameter generating unit 306 and transmits a control signal for controlling the image capturing apparatus 101. Also, the image capturing apparatus control unit 307 transmits a control signal for controlling the image capturing apparatus 101 on the basis of the operation information input in the operation information obtaining unit 305. Note that at least one piece of information corresponding to the operation information obtained by the operation information obtaining unit 305 is held in a storage apparatus such as the RAM 203 or the like, and the parameter generating unit 306 and the image capturing apparatus control unit 307 may reference the RAM 203 or the like and obtain the information.

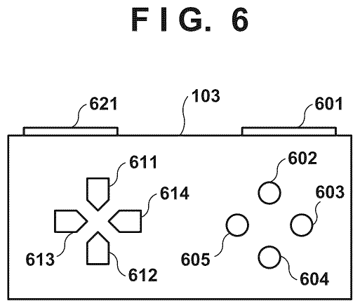

An example of the controller 103 according to the present embodiment and operations using the controller 103 will now be described using FIG. 6. In the present embodiment, as the controller 103, a typical gamepad such as that illustrated in FIG. 6 is used. For example, when the controller 103 receives an operation of buttons 601 to 605 and buttons 611 to 614, the controller 103 transmits operation information to the operation information obtaining unit 305. The operation information obtaining unit 305 transmits the obtained operation information to the parameter generating unit 306 and the image capturing apparatus control unit 307. Accordingly, the image capturing apparatus 101 can be controlled by the user operating the controller 103.

An example of the relationship between operation of each button of the controller 103 and control of the image capturing apparatus 101 will be described below. For example, the speed of the pan and tilt of the image capturing apparatus 101 is controlled according to the degree of how much the button 601 is pressed down by the user. For example, a state in which the button 601 is not pressed down is represented by 0.0, and a state in which the button 601 is fully pressed down is represented by 1.0. The controller 103 notifies the operation information obtaining unit 305 of a value between 0.0 and 1.0, according to the pressing down degree as the operation information. The operation information obtaining unit 305 supplies the obtained value to the parameter generating unit 306 as speed information. The parameter generating unit 306 determines the control speed of the pan value and the tilt value on the basis of the speed information.

Also, by the user pressing the button 602, the information processing apparatus 102 may be instructed to move the angle of view captured by the image capturing apparatus 101 to the initial position. Here, the initial position may be a position corresponding to the first value from among the first target group or may be a predetermined position such as a position corresponding to an initial orientation of the image capturing apparatus 101, for example. When the operation information obtaining unit 305 obtains the operation information, the operation information obtaining unit 305 transfers the information to the image capturing apparatus control unit 307, and the image capturing apparatus control unit 307 controls the image capturing apparatus 101 to return the angle of view to the initial state. Also, for example, in a case where the operation information obtaining unit 305 receives the operation information, the operation information obtaining unit 305 may transfer this information to the target updating unit 304, and the target updating unit 304 may return the first target and the second target to the initial value. Note that the target updating unit 304 may return the first target and the second target to the initial value in response to the angle of view of the image capturing apparatus 101 returning to the initial value via the camera information of the image capturing apparatus 101.

Also, by the user pressing the button 603, the information processing apparatus 102 may be instructed to start or resume tracking and image capture. When the operation information obtaining unit 305 obtains the operation information, the operation information obtaining unit 305 may store the information indicating the tracking state set to “tracking” in the RAM 203, for example. The image capturing apparatus control unit 307 references the RAM 203 and transmits to the image capturing apparatus 101 the control parameter obtained from the parameter generating unit 306 while the information indicating the tracking state is set to “tracking”. Note that the operation information obtaining unit 305 may directly notify the image capturing apparatus control unit 307 of the information instructing to start or resume tracking and image capture. Accordingly, a restriction may be placed on control to enable tracking and image capture only in a case where there is an instruction from a user. Also, while the information indicating the tracking state is set to “tracking”, for example, a restriction may be placed so that operation information from operation of the button 602 is not transmitted. Accordingly, during tracking and image capture, the angle of view captured by the image capturing apparatus 101 may be made not to move to the initial position.

Also, by the user pressing the button 604, the information processing apparatus 102 may be instructed to suspend tracking and image capture. When the operation information obtaining unit 305 obtains the operation information, the operation information obtaining unit 305 may store the information indicating the tracking state set to “suspended” in the RAM 203, for example. When the image capturing apparatus control unit 307 references this information, the image capturing apparatus control unit 307 stops tracking and image capture by transmitting a control signal for stopping the PTZ control to the image capturing apparatus 101. Note that the operation information obtaining unit 305 may directly notify the image capturing apparatus control unit 307 of the information instructing to suspend tracking and image capture.

Also, by the user pressing the button 605, the information processing apparatus 102 may be instructed to end tracking and image capture. When the operation information obtaining unit 305 obtains the operation information, the operation information obtaining unit 305 stores the information indicating the tracking state set to “end” in the RAM 203. Also, the image capturing apparatus control unit 307 ends tracking and image capture by transmitting a control signal to the image capturing apparatus 101 to end PTZ control.

Also, the user may instruct the information processing apparatus 102 to control the zoom in the telephoto direction while the button 611 is pressed and in the wide-angle direction while the button 612 is pressed. The operation information obtaining unit 305 obtains operation information indicating whether or not the button 611 and the button 612 is pressed (amount of time pressed or the like) and transmits this operation information to the parameter generating unit 306. The parameter generating unit 306 generates a parameter to control the zoom on the basis of this information. Accordingly, when performing image capture while tracking a plurality of objects, image capture including close-ups of a specific object, fitting the entire object in the angle of view, and the like can be performed. Note that for zooming, an operation from the user may be unable to be received. Also, for example, the zoom function may be designated to on/off using the button 613 and the button 614, for example. Note that the change speed of the Z value in the telephoto direction (or the wide-angle direction) of the image capturing apparatus 101 may be controlled by the amount of time the button 611 (or the button 612) is pressed. For example, the change speed of the Z value of the image capturing apparatus 101 may increase the longer the amount of time the button is pressed. Also, the zoom of the image capturing apparatus 101 may be controlled in the telephoto direction (or the wide-angle direction) by the button 611 (or the button 612) being pressed and not the amount of time pressed. Furthermore, the change speed of the Z value of the image capturing apparatus 101 may be controlled by the number of presses. For example, in a case where the button 611 is pressed once, the zoom of the image capturing apparatus 101 may be changed in the telephoto direction at a predetermined speed. Also, in this state, in a case where the button 611 is pressed once again, the zoom of the image capturing apparatus 101 may be changed in the telephoto direction at a faster speed than the predetermined speed of when pressed once. In this state, in a case where the button 611 is further pressed once, the zoom of the image capturing apparatus 101 may be changed in the telephoto direction even faster. On the other hand, in this state, in a case where the button 612 is pressed once, the zoom of the image capturing apparatus 101 may be changed in the telephoto direction at the same speed as when the button 611 is pressed twice. In other words, whether to change the zoom in the telephoto direction or the wide-angle direction and the change speed may be controlled by the number of presses of each of the button 611 and the button 612. Also, to simplify user operation, each of the button 611 and the button 612 may be a button for controlling the zoom change speed. For example, the button 611 may be used as a button for increasing the zoom change speed, and the button 612 may be used as a button for decreasing the zoom change speed. In this case, the target value of the zoom value may be set to any of the zoom value of the next first target, the zoom value of the next second target, and the zoom value corresponding to the next preset ID.

### Processing Flow

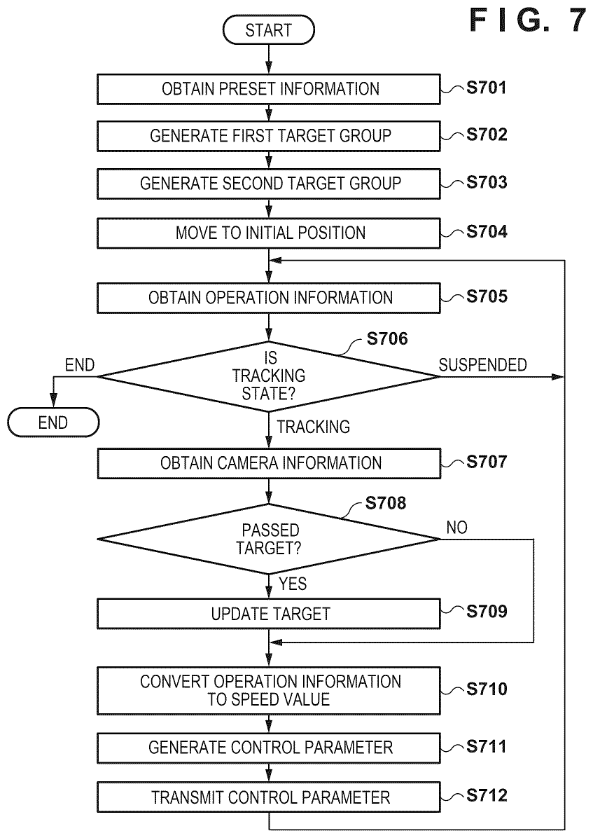

Next, the processing for controlling the image capturing apparatus 101 executed by the information processing apparatus 102 will be described using FIG. 7. Note that hereinafter, the functional units illustrated in FIG. 3 are designated as the operation executing entities. These functional units may be implemented using the CPU 201 or dedicated hardware, and thus it may be interpreted that each processing step is executed by the CPU 201 or the like.

In S701, the camera information obtaining unit 301 obtains preset information corresponding to the ID obtained from the image capturing apparatus 101 or the ID designated by a user operation or the like as initialization processing, for example. Also, in S702, the first target group generating unit 302 generates a first target group by executing spline interpolation processing, for example, using the preset information obtained in S701. Also, in S703, the second target group generating unit 303 generates a second target group from the first target group generated in S702.

Also, in S704, the image capturing apparatus control unit 307 controls the image capturing apparatus 101 to move the PTZ value of the image capturing apparatus 101 to a value corresponding to the start point of the first target group generated in S702. Also, at this time, the first target and the second target to be used in tracking and image capture are set to an initial value.

In S705, the operation information obtaining unit 305 obtains operation information of the buttons 601 to 605 from the controller 103. At this time, the operation information obtaining unit 305 stores information indicating the tracking state set to either “tracking”, “suspended”, or “end” according to the operation information in the RAM 203. In S706, for example, the CPU 201 confirms the information indicating the tracking state stored in the RAM 203 and switches the processing according to the confirmation result. In a case where the information indicating the tracking state is “suspended”, the CPU 201 returns the processing to S705 and waits for an operation via the operation information obtaining unit 305 to set the information indicating the tracking state to “tracking”. In a case where the information indicating the tracking state is “end”, the image capturing apparatus control unit 307 executes processing for causing the image capturing apparatus 101 to end the tracking and image capture. In a case where the information indicating the tracking state is “tracking”, the CPU 201 advances the processing to S707.

In S707, the camera information obtaining unit 301 obtains the camera information (current PTZ value) from the image capturing apparatus 101. Note that the camera information obtaining unit 301 may periodically obtain this information. Also, the camera information obtaining unit 301 may obtain this information even when not tracking or may obtain this information only during tracking. Then, in S708, the target updating unit 304 determines whether or not the position of the angle of view corresponding to the current PTZ value obtained in S707 has passed the position corresponding to the currently set first target. Note that this determination may be performed only by comparison of PTZ values and not take into account the geographic location. In other words, whether or not the distance between the current PTZ value and the PTZ value indicated by the first target is equal to or less than a predetermined value may be determined. For example, this distance may be calculated via {(Panₜ−Pan_{c})2+(Tiltₜ−Tilt_{c})²+(Zoomₜ−Zoom_{c})²}^{1/2}. Note that Pan represents the pan value, Tilt represents the tilt value, and Zoom represents the zoom value. Also, the subscript t corresponds to the PTZ value of the first target, and the subscript c corresponds to the current PTZ value. When it is determined that the position of the angle of view corresponding to the current PTZ value has passed the position corresponding to the currently set first target, in S709, the target updating unit 304 updates the first target and the second target. On the other hand, when it is determined that the position of the angle of view corresponding to the current PTZ value has not passed the position corresponding to the currently set first target, the target updating unit 304 advances the processing to S710 without updating the first target and the second target.

In S710, the operation information obtaining unit 305 executes processing for converting the operation information obtained in S705 into a speed value. In a case where the range of the PTZ value of the image capturing apparatus 101 is from 0 to 100, the operation information obtaining unit 305 maps the operation information with a range from 0.0 to 1.0 to the speed value of 0 to 100. Then, the operation information obtaining unit 305 transmits the speed value to the parameter generating unit 306. Note that the method for mapping from the operation information to the speed value may be simple normalization. In other words, by multiplying the value indicated by the operation information by the width of the PTZ value (100 in a case where the value range is from 0 to 100, 80 in a case where the value range is from 20 to 100, and the like), the speed value may be calculated. Also, for example, the value indicated by the operation information is sorted into ranges of 0.0 to 0.5, 0.5 to 0.8, 0.8 to 1.0 and normalized into 0 to 20, 20 to 70, and 70 to 100. In other words, when a value “x” indicated by the operation information is in the range 0.0 to 0.5, the speed information may be represented as 20 (x/0.5). Also, in a case where x is in the range 0.5 to 0.8, the speed information may be represented by 50{(x−0.5)/0.3}+20, and in a case where x is in the range 0.8 to 1.0, the speed information may be represented by 30(x−0.8)/0.2+70. Accordingly, high-speed tracking can be performed by quickly changing the PTZ value in a high speed region while finely controlling the PTZ value in a low speed region. Note that these are merely examples, and the operation information may be mapped to a speed value on the basis of a value range (for example, from 0 to 50) corresponding to a portion of the range of the PTZ value. In other words, the operation information obtaining unit 305 may map the operation information with a range from 0.0 to 1.0 to a speed value from 0 to 50. Also, for example, mapping to a speed value may be performed by setting the distance between the current PTZ value and the next first target PTZ value may be set to the maximum value (in other words, in a case where the distance is 10, only a speed value of 0 to 10 is used).

Thereafter, in S711, the parameter generating unit 306 generates a parameter for controlling the image capturing apparatus 101 on the basis of the speed value obtained in S710 and the first target. The parameter generating unit 306 calculates movement speed Speedₚₐₙ of the pan value and movement speed Speedₜᵢₗₜ of the tilt using the following Formula (2) and Formula (3).

$$[ {Speed}_{pan} = Speed * \frac{{Norm}_{pan}}{{Norm}_{pan} + {Norm}_{tilt}} \qquad ( 2 )$$

$${Speed}_{tilt} = Speed * \frac{{Norm}_{tilt}}{{Norm}_{pan} + {Norm}_{tilt}} \qquad ( 3 )$$

Here, the value Speed represents the speed value mapped in S710. Also, Normₚₐₙ and Normₜᵢₗₜ represent the difference between the current pan value and tilt value obtained is S707 and the pan value and tilt value of the first target. The difference in pan values can be represented as |Panₜ−Pan_{c}| using Panₜ and Pan_{c} described above. In a similar manner, the difference in tilt values may be represented as |Tilt₁−Tilt_{c}|. Here, |y| is y as an absolute value.

Also, the parameter generating unit 306 can calculate the speed of the zoom via the following Formula (4).

$${Speed}_{zoom} = \frac{{Norm}_{zoom}}{{Norm}_{pan , tilt} / Speed} \qquad ( 4 )$$

Here, Norm_{pan,tilt} is the difference between the pan value and tilt value of the camera information obtained in S707 and the pan value and tilt value of the first target. This different may be represented as |Panₜ−Pan_{c}|+|Tilt₁−Tilt_{c}|, for example. Also, Norm_{zoom} is a difference (|Zoomₜ−Zoom_{c}|) between the zoom value of the camera information obtained in S707 and the zoom value of the first target. Note that the speed of the zoom may be a fixed pre-designated value.

Note that in the example described here, a parameter is calculated on the basis of the current camera information and first information. However, instead of the first information, second information may be used to calculate this parameter. The parameter generating unit 306 generates a control parameter for controlling the image capturing apparatus 101 on the basis of the calculated PTZ speed and the second target and supplies the generated control parameter to the image capturing apparatus control unit 307.

The parameter generating unit 306 adds the speed value calculated via Formula (2) to Formula (4) described above to the PTZ value based on the preset information, for example. For example, if the vector PTZ indicating the PTZ value (pan value, tilt value, and zoom value) based on the preset information at time t is vector PTZ(t), the actual PTZ value at this time is PTZ(t)+ΔPTZ(t). If the PTZ value based on the preset information at time t+Δt is represented as PTZ(t+Δt), in a case where there is no speed value operation, the PTZ value of the image capturing apparatus 101 at this time is PTZ(t+Δt)+ΔPTZ(t). In a case where there is a speed value operation, the PTZ value of the image capturing apparatus 101 at this time is PTZ(t+Δt)+ΔPTZ(t)+Speed(t+Δt). Speed (t+Δt) here is a vector with the speed values of the pan value, tilt value, and zoom value calculated via Formula (2) to Formula (4) as components. The accumulated value of the speed values up until time t is represented as ΔPTZ(t), and ΔPTZ(t+Δt)=ΔPTZ(t)+Speed(t+Δt). Note that Δt may be a duration corresponding to one frame, for example, or may be a predetermined duration discretionarily set such as a duration corresponding to a predetermined number of frames. For example, Δt may be set to a duration for updating the preset information in the case of no change to the change speed of the PTZ value. Note that in a case where Δt is a couple of second or a sufficiently long amount of time, for example, the parameter generating unit 306 may gradually change the PTZ value to the PTZ value calculated as described above at time t+Δt. For example, if the number of frames corresponding to Δt is m, for each frame, the PTZ value corresponding to each frame may be calculated so that the PTZ value changes by {PTZ(t+Δt)−PTZ(t)+Speed(t+Δt)}/m.

Thereafter, in S712, the image capturing apparatus control unit 307 transmits a control parameter generated in S711 to the image capturing apparatus 101.

Note that the movement speed of the PTZ value may be decreased by the user pressing the button 621 on the controller 103, for example. In this case, how fast the speed is decreased is defined in a similar manner as when operating the button 601 as described above. For example, Speed(t+Δt) described above is set to a value with the inverted sign (plus/minus) of the value when the button 601 is operated. Note that when Speed(t+Δt) becomes PTZ(t)−PTZ(t+Δt), the value of PTZ stops changing between time t and time t+Δt. Thus, Speed(t+Δt) may be calculated with the value PTZ(t)−PTZ(t+Δt) as a threshold value so that the order of the preset position is not inverted. Note that the button 621 may be made unable to be used. For example, when the button 601 is pressed while the button 614 is pressed, the change speed of the PT value may be increased, and when the button 601 is pressed while the button 613 is pressed, the change speed of the PT value may be decreased. Also, the relationship between the button operations and the control executed in the information processing apparatus 102 described above is merely an example, and other relationships may be used. Note that the zoom value may be fixed, and in this case, the zoom value may not be taken into account in the processing described above.

In this manner described above, image capture can be performed while appropriately tracking an object smoothly and in response to a user operation without deviating from a path preset as preset information.

According to the present disclosure, the user-friendliness of image capture based on a preset can be enhanced.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-204138, filed Nov. 22, 2024, which is hereby incorporated by reference herein in its entirety.

What is claimed is:

1. An information processing apparatus, comprising:
one or more memories configured to store instructions; and
one or more processors configured to execute the instructions to:
obtain information indicating a plurality of setting values for setting an angle of view of an image capturing apparatus, the plurality of setting values corresponding to a plurality of positions included in a predetermined path for performing image capture while moving the angle of view along the predetermined path,
set a target value for setting the angle of view different from the plurality of setting values, based on two setting values included in the plurality of setting values, and
change a setting of the image capturing apparatus toward the target value.

2. The information processing apparatus according to claim 1, wherein
the one or more processors further execute the instructions to obtain information indicating the angle of view of the image capturing apparatus,
the two setting values include a first setting value and a second setting value, and
while the angle of view of the image capturing apparatus is changing from the first setting value toward the target value, the target value is updated based on a third setting value different from the first setting value and the second setting value, in a case where a difference between the setting of the image capturing apparatus and the second setting value is equal to or less than a predetermined value.

3. The information processing apparatus according to claim 2, wherein
the target value is set so that a position corresponding to the target value is set behind a position on the predetermined path corresponding to the second setting value as seen from a position on the predetermined path corresponding to the first setting value, based on the first setting value and the second setting value.

4. The information processing apparatus according to claim 1, wherein
the setting of the image capturing apparatus, the plurality of setting values, and the target value each include at least a pan value and a tilt value of the image capturing apparatus.

5. The information processing apparatus according to claim 4, wherein
the setting of the image capturing apparatus, the plurality of setting values, and the target value each include at least a zoom value of the image capturing apparatus.

6. The information processing apparatus according to claim 1, wherein
the one or more processors further execute the instructions to receive operation information indicating a user operation relating to speed for when changing the setting of the image capturing apparatus toward the target value, and
a speed for changing the setting of the image capturing apparatus is controlled based on the operation information.

7. The information processing apparatus according to claim 6, wherein
operation information indicating a user operation relating to a zoom value in the setting of the image capturing apparatus is further received, and
a zoom value in the setting of the image capturing apparatus is changed based on the operation information indicating the user operation relating to the zoom value.

8. The information processing apparatus according to claim 6, wherein
predetermined operation information relating to whether to execute processing to change the setting of the image capturing apparatus to move an angle of view along the predetermined path is further received, and
the setting of the image capturing apparatus is changed in a duration of a state of executing the processing, and the setting of the image capturing apparatus is not changed in a duration of a state of not executing the processing.

9. A control method executed by an information processing apparatus, the control method comprising:
obtaining information indicating a plurality of setting values for setting an angle of view of an image capturing apparatus, the plurality of setting values corresponding to a plurality of positions included in a predetermined path for performing image capture while moving the angle of view along the predetermined path,
setting a target value for setting the angle of view different from the plurality of setting values, based on two setting values included in the plurality of setting values, and
changing a setting of the image capturing apparatus toward the target value.

10. A non-transitory computer-readable storage medium that stores a program for causing a computer included in an information processing apparatus to perform a control method comprising:
obtaining information indicating a plurality of setting values for setting an angle of view of an image capturing apparatus, the plurality of setting values corresponding to a plurality of positions included in a predetermined path for performing image capture while moving the angle of view along the predetermined path,
setting a target value for setting the angle of view different from the plurality of setting values, based on two setting values included in the plurality of setting values, and
changing a setting of the image capturing apparatus toward the target value.
